(19) United States
(12) Patent Application Publication
(10) Pub. No.: US 2016/0207122 A1
(43) Pub. Date: Jul. 21, 2016

(54) Blade fastening device having cuttign fluid guide grooves on a blade

(71) Applicant: X'POLE PRECISION TOOLS INC., Taoyuan City (TW)

(72) Inventor: Peter CHEN, Taoyuan County (TW)

(21) Appl. No.: 14/598,197

(22) Filed: Jan. 15, 2015

(51) Int. Cl. B23B 51/06; B23C 5/10

(52) U.S. Cl. CPC B23B 51/06; B23C 5/10; B23B 2250/12; B23B 2251/408; B23C 2210/40; B23C 2250/12

(57) ABSTRACT

A blade for a blade fastening device is provided with a body having a first end fastened in a blade seat and a second end extending out of the blade seat; a machining point formed at the second end of the body for machining an object being machined; and at least one cutting fluid groove formed on a surface of the body and extending from the second end of the body to the machining point. The blade can guide cutting fluid to an object being machined via the at least one groove so as to clear swarf left at a cutting site and decrease temperature at the cutting site. Further, the structural strength of the blade can be maintained.

### BACKGROUND OF THE INVENTION

1. Field of the Invention The invention relates to blade fastening devices and more particularly to a blade fastening device having grooves on a surface of a blade for guiding cutting fluid to an object being machined at a cutting site so that swarf can be effectively cleared.

2. Description of Related Art

CNC (computer numerical control) lathes are widely employed as technologies advance. The CNC lathes can perform cutting, drilling, etc. on an object. For example, a lathe may be required to cut an object by using one of different blades. Blade fastening device plays a big role when operating the CNC lathe.

As shown in FIG. 1, in a typical lathe, a blade 80 is secured to a blade seat 90 and has an axial channel 70. Cutting fluid can be sprayed to a cutting site and/or cutting fluid can flow to the cutting site through the channel 70 in a cutting operation. However, the spraying strength is relatively weak due to the axial location of the channel 70. Thus, more cutting fluid is required to achieve the desired clearing of swarf left at the cutting site. Forming a plurality of holes through the blade 80 for flowing cutting fluid has been proposed for solving the problem. However, the holes may significantly decrease the structural strength of the blade 80.

Thus, the need for improvement still exists.

### SUMMARY OF THE INVENTION

It is therefore one object of the invention to provide a blade for a blade fastening device comprising a body having a first end fastened in a blade seat and a second end extending out of the blade seat; a machining point formed at the second end of the body for machining an object being machined; and at least one cutting fluid groove formed on a surface of the body.

Preferably, each of the at least one cutting fluid groove is helical.

Preferably, each of the at least one cutting fluid groove is straight.

Preferably, the machining point is configured as an object machining member.

Preferably, the at least one cutting fluid groove extends from the second end of the body to the machining point.

It is envisaged by the invention that the blade can guide cutting fluid to an object being machined via the at least one groove so as to clear swarf left at a cutting site and decrease temperature at the cutting site. Further, the cutting operation is made easy. Furthermore, the structural strength of the blade can be maintained.

### BRIEF DESCRIPTION OF THE DRAWINGS

The invention, as well as its many advantages, may be further understood by the following detailed description and drawings in which:

FIG. 1 is a longitudinal sectional view of a conventional blade fastening device;

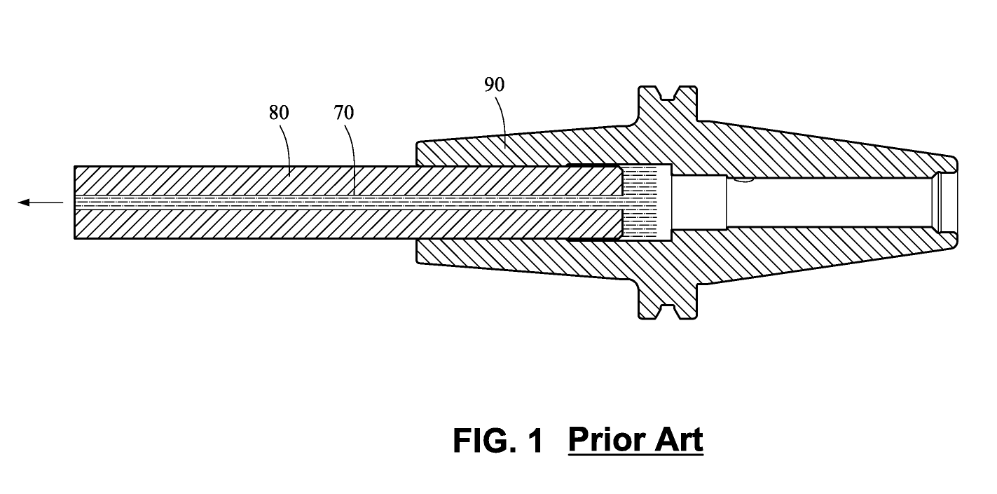

FIG. 2 is a perspective view of a blade fastening device incorporating a first preferred embodiment of blade according to the invention;

FIG. 3 is a longitudinal sectional view of FIG. 2;

FIG. 4 is a perspective view of the blade shown in FIG. 2;

FIG. 5 is a perspective view of a second preferred embodiment of blade according to the invention; and

FIG. 6 is a perspective view of a third preferred embodiment of blade according to the invention.

### DETAILED DESCRIPTION OF THE INVENTION

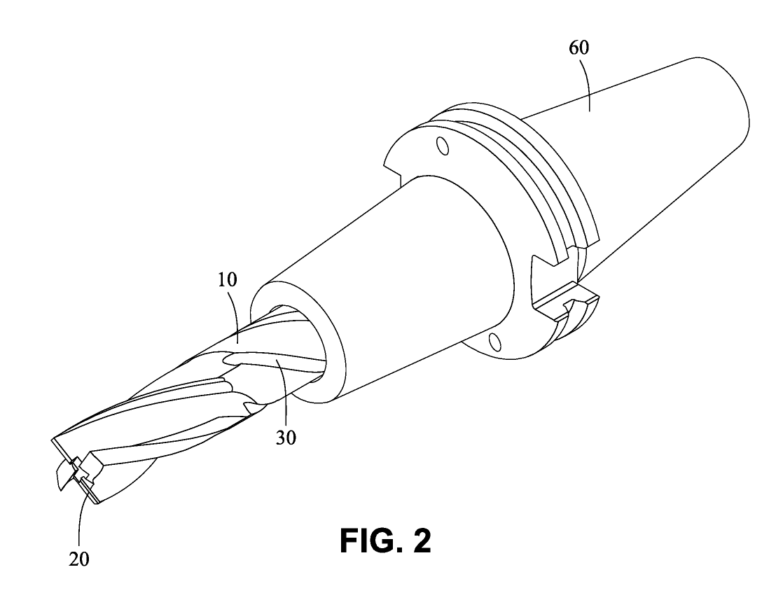

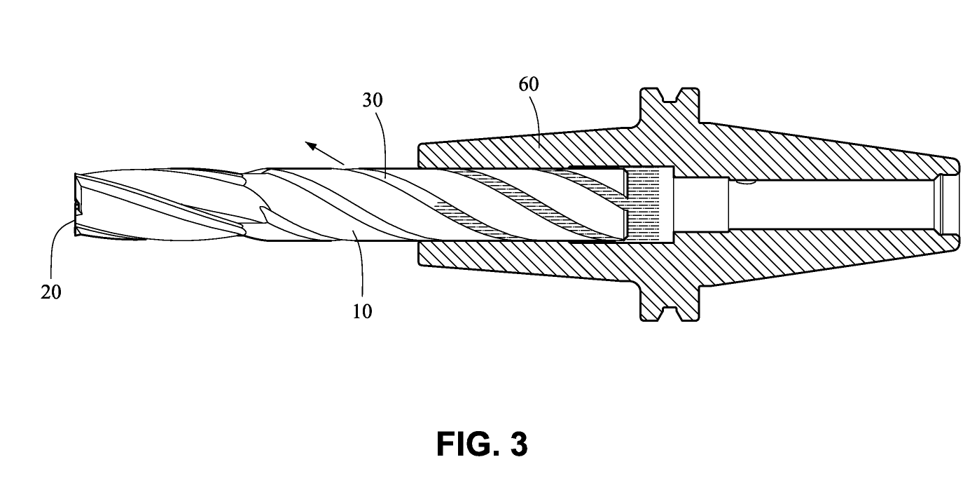

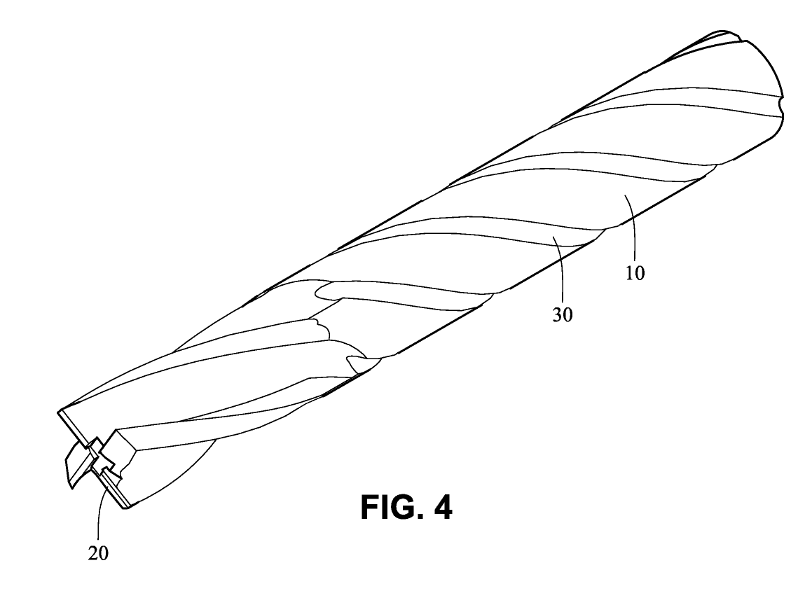

Referring to FIGS. 2 to 4, a blade fastening device incorporating a first preferred embodiment of blade in accordance with the invention is shown. A blade seat 60 is secured to a body 10 of the blade by fastening a portion of the body 10 therein. A forward portion of the body 10 is exposed. The body 10 is cylindrical and comprises the following components as discussed in detail below.

A machining point 20 is provided at a forward end of the body 10. The machining point 20 is configured as a tool for machining on an object. A plurality of helical grooves 30 are formed on a surface of the body 10. The helical grooves 30 extend from a rear end of the body 10 to the machining point 20. Cutting fluid can flow from rear ends of the helical grooves 30 to forward ends thereof for clearing swarf left at a cutting site and decreasing temperature at the cutting site.

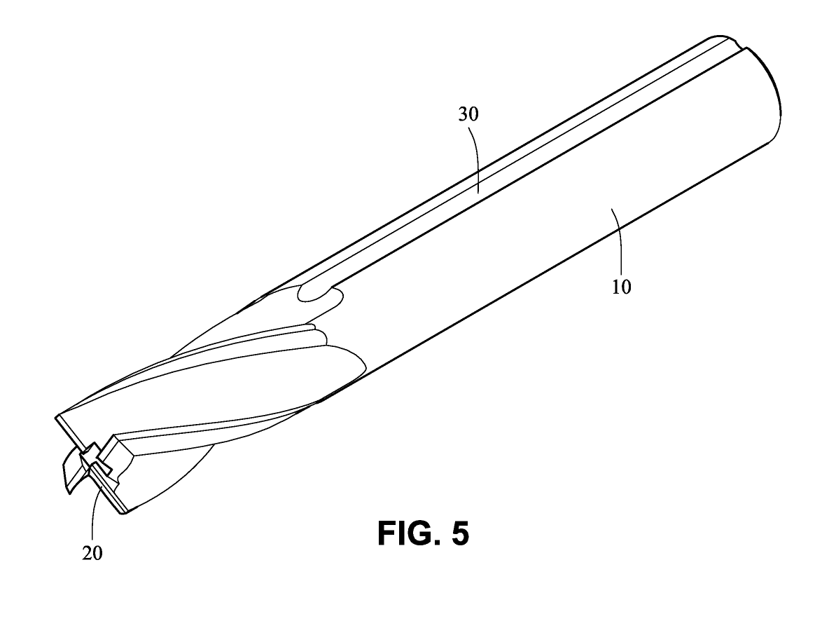

Referring to FIG. 5, a blade fastening device incorporating a second preferred embodiment of blade in accordance with the invention is shown. The characteristics of the second preferred embodiment are described in detail below.

Only one straight groove 30 is formed on a surface of the body 10. The straight groove 30 extends from a rear end of the body 10 to the machining point 20.

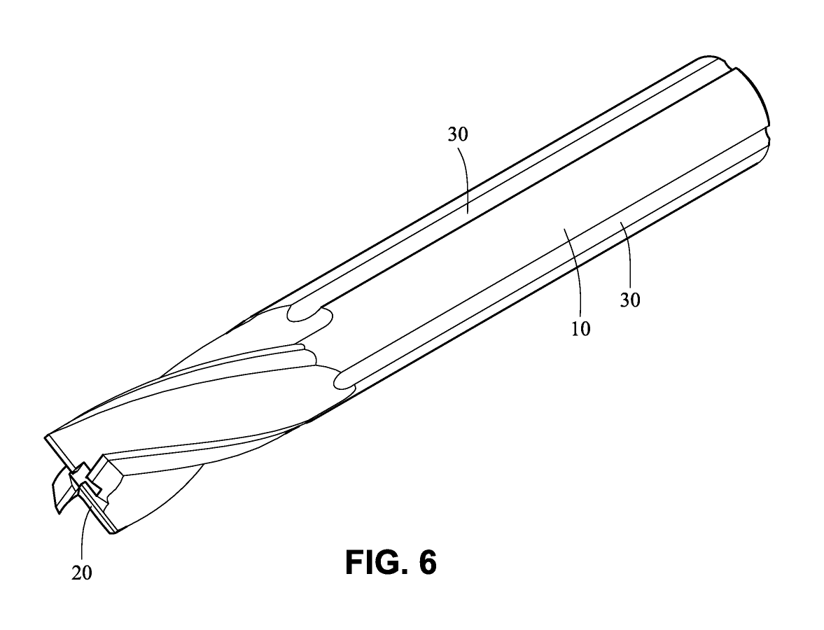

Referring to FIG. 6, a blade fastening device incorporating a third preferred embodiment of blade in accordance with the invention is shown. The characteristics of the third preferred embodiment are described in detail below.

A plurality of parallel straight grooves 30 are formed on a surface of the body 10. The straight grooves 30 extend from a rear end of the body 10 to the machining point 20.

It is envisaged b y the invention that the blade can guide cutting fluid to an object being machined via the groove(s) so as to clear swarf left at a cutting site and decrease temperature at the cutting site. Further, the cutting operation is made easy. Furthermore, the structural strength of the blade can be maintained.

Many changes and modifications in the above described embodiment of the invention can, of course, be carried out without departing from the scope thereof Accordingly, to promote the progress in science and the useful arts, the invention is disclosed and is intended to be limited only by the scope of the appended claims.

What is claimed is:

1. A blade for a blade fastening device comprising:
a body having a first end fastened in a blade seat and a second end extending out of the blade seat;
a machining point formed at the second end of the body for machining an object being machined; and
at least one cutting fluid groove formed on a surface of the body and extending from the second end of the body to the machining point.

2. The blade fastening device of claim 1, wherein each of the at least one cutting fluid groove is helical.

3. The blade fastening device of claim 1, wherein each of the at least one cutting fluid groove is straight.

4. The blade fastening device of claim 1, wherein the machining point is configured as an object machining member.
